(19) United States
(12) Patent Application Publication
(10) Pub. No.: US 2004/0099691 A1
(43) Pub. Date: May 27, 2004

(54) Automatic drink dispenser for limousines, airplanes, boats, and private settings

(76) Inventor: Christophe Obolo, Stamford, CT (US)

Correspondence Address: Christophe Obolo, CEO & Founder D'Abord Products, Inc., P.O. Box 8064, Stamford, CT, 06905, US

(21) Appl. No.: 10/640,527

(22) Filed: Aug. 14, 2003

Related U.S. Application Data
(60) Provisional application No. 60/403,933, filed on Aug. 16, 2002.

(51) Int. Cl. B67D 5/64

(52) U.S. Cl. 222/166; 222/192; 222/146.6

(57) ABSTRACT

The automatic drink server will provide users with security, convenience, accessibility, and luxury of cocktails and other drinks in limousines, airplanes, and boats. The automatic drink sever can also be used in private settings such as bathrooms, kitchens, rotunda, gardens, porches, and balconies. This invention will leave people hands free and permit greater interpersonal interactions during parties and/or traveling. It can be placed near a bathtub for one to use during romantic baths or quiet evenings in balconies, gardens, or boats.

Automatic drink dispenser for limousines, airplanes, boats, and private settings: I, undersigned, Christophe Obolo declares that I am the first and sole inventor of the automatic drink server for Limousines and airplanes. The automatic drink server is specifically designed as a luxurious and convenient item for drinks and including wine, champagne, water, and soft drinks. This automatic drink server encompasses a metallic base that can be bolted to a solid surface, two vertical metallic arms, and a bottle holder consisting of adjustable metallic bars, which are linked to three or two metallic columns. A built-in mechanical and motion-sensitive laser system will permit the use and operation of this machine.

### BACKGROUND OF THE INVENTION

This invention pertains to the field of electronics as related to automatic machines. The automatic drink server is meant to be mounted in cars, limousines, planes, boats, gardens, bathrooms, hallways, kitchen, and offices.

### BRIEF SUMMARY OF THE INVENTION

This invention is an automatic drink server for champagne, wine, and cocktails but it could also be used to serve others drinks and mixtures, thereof. The automatic drink server is specifically designed as a luxurious and convenient item for drinks and including wine, champagne, water, and soft drinks. This automatic drink server encompasses a metallic base that can be bolted to a solid surface, two vertical metallic arms, and a bottle holder consisting of adjustable metallic bars, which are linked to three or two metallic columns. A built-in mechanical and motion-sensitive laser system will permit the use and operation of this machine. Therefore, this system will be activated by a motion sensitive laser system, which is activated when a user directs glass toward the automatic server. The bottle will slowly rotate counterclockwise and toward the user, until the drink poured into the glass. The bottle will rotate clockwise to a vertical and resting position upon withdrawing of the glass from the automatic server, upon filling of glass to user's satisfaction.

### BRIEF DESCRIPTION OF THE DRAWINGS

FIG. 1: Automatic drink server holding six bottles

FIG. 2: Cooling system, with cold plates visible in the base unit

FIG. 3: cold plates with fan at bottom of base unit

FIG. 4: Automatic drink server holding one bottle

### DETAILED DESCRIPTION OF DRAWINGS

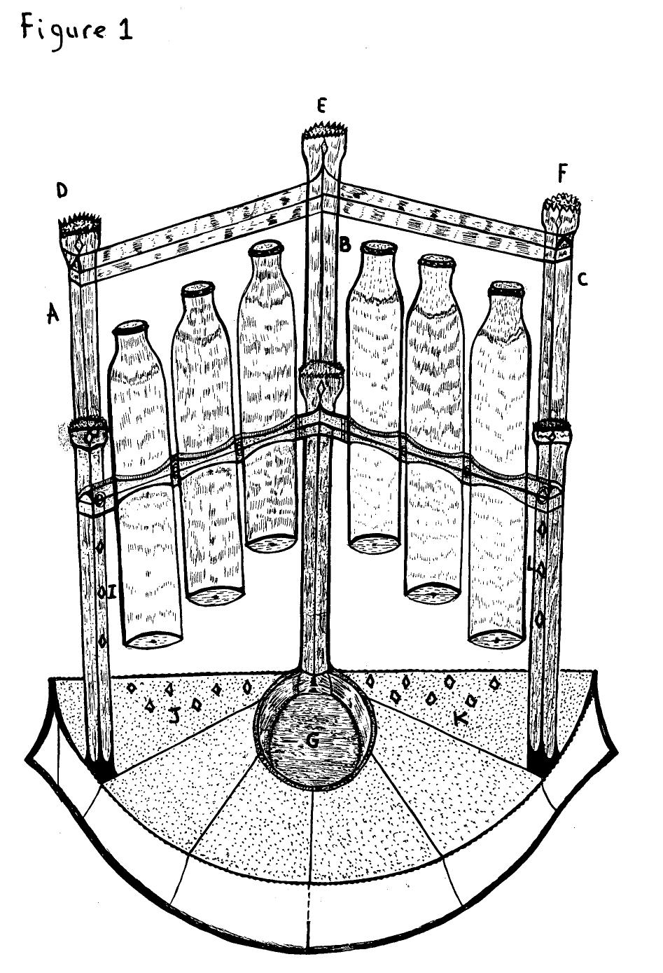

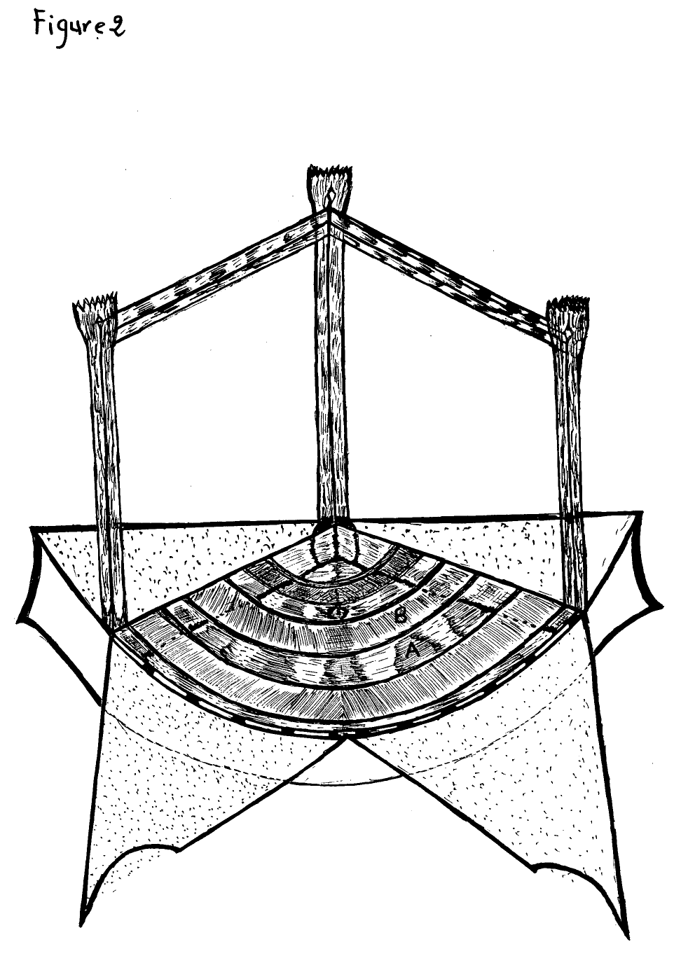

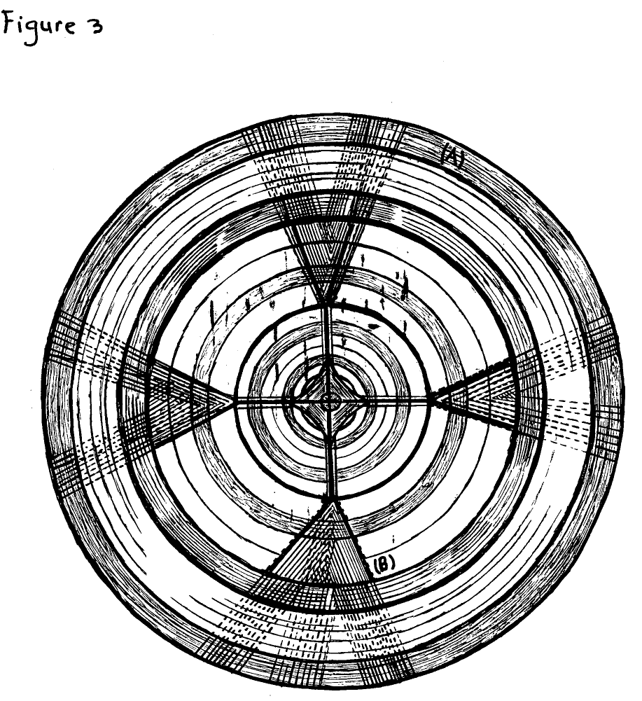

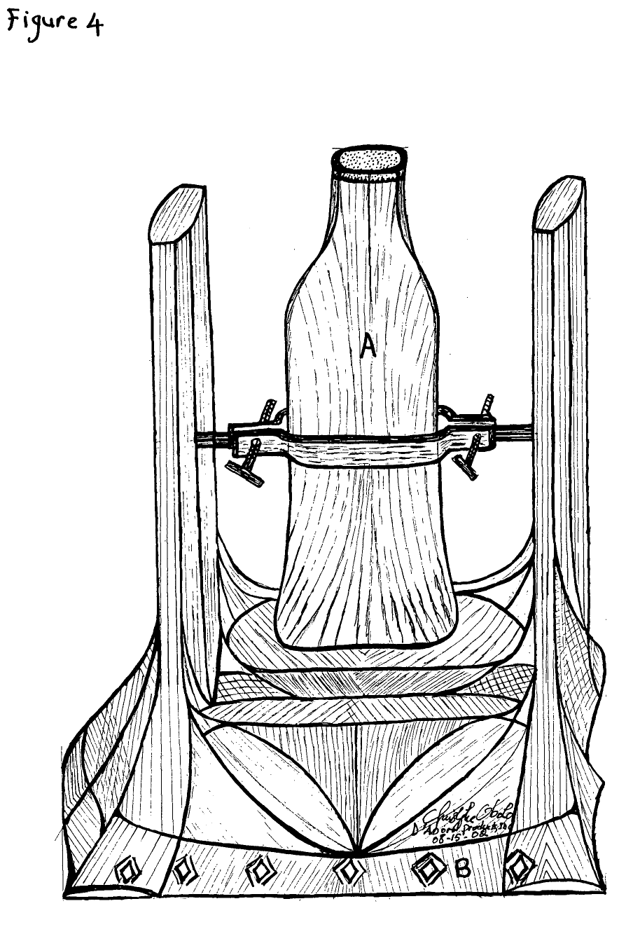

FIG. 1: front view; automatic drink server holding six bottles on the horizontal bar, and following: Three vertical bars (FIGS. 1A, B, C) in which, is mounted a motion-sensitive-laser system. Candleholders or ornaments can be placed atop the server unit (FIGS. 1D, E, F). A central sink (FIG. 1G), for ice and ice scoop. FIG. 2 front view; open base unit showing Cooling system for the automatic server, encased in the server's unit base, with blades (FIG. 2A) alternating cold plates (FIG. 2B), and cooling outlets on vertical columns, and atop the base unit (FIGS. 1I, J, K, L). FIG. 3: front view; cooling system, with alternating cold plates and a fan at the bottom of the base unit. FIG. 4: front view; automatic drink server holding one bottle (FIG. 4A) and showing securing bolts (FIG. 4B)

### DETAILED DESCRIPTION OF THE INVENTION

The automatic drink server for Limousines and airplanes will be made of metal, with rubber and wood or mixtures, thereof This machine will consist of a base from which two or three vertical columns will be mounted. In addition, It will also encompass one or two horizontal arms holding bars for bottles, and a built-in motion-sensitive mechanical and laser system, which will rotate a specific bottle mounted on this machine, counterclockwise, and toward the user. Bottles mounted on this automatic server will slowly rotate toward the glass when a user directs a glass toward a specific bottle. The bottle will return to its vertical and resting position upon moving the glass away from the machine, after glass filling. This automatic drink server will be made of metal, with a built-in motion-sensitive laser and mechanical system, encased in the vertical columns and base of unit. In addition, built-in candleholders are mounted at the very top of the vertical columns. This machine may hold one or more bottles. Specifically designed bottles and glasses may be used with this machine. These bottles and glasses may be encoded to prevent bulk rotation of bottles. Bottle's motion or rotation may be randomized on units holding more than one brand of drinks or bottles.

What I claim as my invention is:

1. Motion-sensitive mechanical and laser system encased in the specifically designed automatic drink server
Glasses and bottles may be coded for randomness and/or ordered serving.
Glasses and bottles may be customized to serve special needs and functions
The automatic drink server may be mounted in cars, limousines, airplanes, boats, houses, or outdoors during celebrations such as weddings or black tie parties
Ventilation and cooling system consisting of a fan and alternating cold plates, enclosed in the base of the automatic drink server, with cold outlets scattered atop the base of the server, and along the vertical bars.
A hot drink version of the automatic drink server, with hot plates and or bars for coffee and/or tea
The dispenser's outer frame may be modified and used as a candle holder
Bottles may be customized and made of light metal or glasses
